(19) United States
(12) Patent Application Publication
(10) Pub. No.: US 2018/0157082 A1
(43) Pub. Date: Jun. 7, 2018

(54) TOUCH PANEL AND METHOD OF MANUFACTURING THE SAME

(71) Applicant: Shenzhen China Star Optoelectronics Technology Co. Ltd., Shenzhen (CN)

(72) Inventor: Jun WANG, Shenzhen (CN)

(73) Assignee: Shenzhen China Star Optoelectronics Technology Co. Ltd., Shenzhen (CN)

(21) Appl. No.: 14/897,700

(22) PCT Filed: Oct. 14, 2015
(86) PCT No.: PCT/CN2015/091890

§ 371 Date: Feb. 6, 2018

(30) Foreign Application Priority Data
Sep. 15, 2015 (CN) 201510586624.0

(51) Int. Cl. G02F 1/1333; G06F 3/044; G02F 1/1335

(52) U.S. Cl. CPC G02F 1/13338; G06F 2203/04103; G02F 1/133512; G06F 3/044

(57) ABSTRACT

Provided is a touch panel and a method of manufacturing the touch panel. This belongs to the field of display technologies, and can be used to improve manufacturing efficiency and lower manufacturing costs of the touch panel.

### CROSS-REFERENCE TO RELATED APPLICATIONS

The present application claims the priority of Chinese patent application CN 201510586624.0, entitled “Touch panel and method of manufacturing the same” and filed on Sep. 15, 2015, the entirety of which is incorporated herein by reference.

### FIELD OF THE INVENTION

The present disclosure relates to the field of display technologies, and in particular, to a touch panel and a method of manufacturing the touch panel.

### BACKGROUND OF THE INVENTION

Touch panels (TPs for short), as man-machine interaction input devices, are widely used in mobile phones, personal digital assistants (PDAs for short), multimedia, public information inquiry systems, etc. Users can touch the touch panel with fingers or special pens, to perform identifying and selecting operations on texts, symbols, menus, and the like as displayed by a display panel located behind the touch panel, thereby realizing an input function.

Among all touch panels, capacitive touch panels are now more widely used. In the prior art, in connection with a capacitive touch panel, a transparent conductive layer is typically formed on a base substrate, followed by procedures such as exposure and etching that are performed on the transparent conductive layer through corresponding photomasks, so as to manufacture a touch electrode. Subsequently, a black color barrier layer can be formed on the transparent conductive layer, which precedes formation of a black matrix in procedures like exposure and etching through a photomask corresponding to the black matrix.

Because the exposure procedure performed on the transparent conductive layer and that performed on the black color barrier layer are independent from each other, and different photomasks are respectively used. As a result, inaccuracy generated during replacement of the photomasks will affect the relative position between the touch electrode and the black matrix. Moreover, a manufacturing procedure of the photomask necessarily includes steps such as coating, soft bake, hard bake, exposure, development, etching, and removal of photoresist. This takes a relatively long manufacturing time, thereby lowering production efficiency and increasing production costs of the touch panel.

### SUMMARY OF THE INVENTION

The present disclosure aims to provide a touch panel and a method of manufacturing the touch panel, thereby improving manufacturing efficiency of the touch panel, and lowing manufacturing costs thereof.

According to a first aspect of the present disclosure, a touch panel is provided, comprising: a based substrate; a touch electrode arranged on the base substrate; and a black matrix located on the touch electrode, wherein the black matrix and the touch electrode have a same pattern, and completely coincide with each other.

Optionally, each of the black matrix and the touch electrode comprises horizontal rows and longitudinal columns perpendicular to each other.

Optionally, where the touch electrode is continuously arranged, the black matrix is continuously arranged also; and where the touch electrode is discontinuously arranged, the black matrix is discontinuously arranged also.

Optionally, the black matrix and/or the touch electrode are each discontinuous at a connecting position between corresponding horizontal row and longitudinal column.

The present disclosure brings about the following beneficial effects. According to the embodiment of the present disclosure, due to location of the black matrix on the touch electrode, the same and completely coinciding patterns between the black matrix and the touch electrode, and different material of the black matrix from that of the touch electrode, the black matrix may not only shade light, but also function as a mask of the touch electrode during formation of the touch electrode. As a result, not only the alignment accuracy between the black matrix and the touch electrode can be improved, but a photomask for the black matrix or the touch electrode can be saved as well. Therefore, the technical solution provided in the embodiment of the present disclosure is beneficial in simplifying a manufacturing procedure, cutting down manufacturing costs, and improving manufacturing efficiency of the touch panel.

According to a second aspect of the present disclosure, a method of manufacturing a touch panel is provided, comprising the steps of:

providing a base substrate;

forming a transparent conductive layer and a black color barrier layer on the base substrate successively;

performing a patterning procedure on the color barrier layer by means of a photomask with which a touch electrode is formed, so as to form a black matrix; and

performing an etching procedure on the transparent conductive layer based on a formed pattern of the black matrix, so as to form the touch electrode.

Optionally, the step of performing a patterning procedure on the color barrier layer by means of a photomask with which a touch electrode is formed, so as to form a black matrix includes the sub-steps of:

forming photoresist on the black color barrier layer;

exposing the photoresist by means of the photomask with which the touch electrode is formed;

developing the photoresist that has been exposed; and

etching the black color barrier layer based on a formed pattern of the photoresist after being developed, so as to form the black matrix.

Optionally, each of the black matrix and the touch electrode comprises horizontal rows and a longitudinal columns perpendicular to each other.

Optionally, where the touch electrode is continuously arranged, the black matrix is continuously arranged also; and where the touch electrode is discontinuously arranged, the black matrix is discontinuously arranged also.

Optionally, the black matrix and/or the touch electrode are each discontinuous at a connecting position between corresponding horizontal row and longitudinal column.

Other features and advantages of the present disclosure will be further explained in the following description, and partly become self-evident therefrom, or be understood through implementation of the present disclosure. The objectives and advantages of the present disclosure will be achieved through the structure specifically pointed out in the description, claims, and the accompanying drawings.

### BRIEF DESCRIPTION OF THE DRAWINGS

In order to explicitly illustrate the technical solution in the embodiments of the present disclosure, accompanying drawings that will be referred to in illustrating the embodiments will be simply explained, in which:

FIG. 1 schematically shows the structure of a touch panel according to an embodiment of the present disclosure;

FIG. 2 schematically shows the pattern of a black matrix provided in the embodiment of the present disclosure;

FIG. 3 schematically shows a flow chart of a method for manufacturing the touch panel provided in the embodiment of the present disclosure; and

FIGS. 4-6 schematically show manufacturing steps of the touch panel provided in the embodiment of the present disclosure.

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It is important to note that as long as there is no structural conflict, all the technical features mentioned in all the embodiments may be combined together in any manner, and the technical solutions obtained therefrom all fall within the scope of the present disclosure.

In a flat panel display device such as a thin film transistor liquid crystal display (TFT-LCD for short) device, a touch panel can be configured to have an imbedded structure, and therefore integrated into one piece with a display panel. Such an integrated structure can, to a certain degree, reduce thickness of the entire display device and simplify a manufacturing procedure.

The TFT-LCD device typically comprises a TFT array substrate, a color filter (CF for short) substrate fit to the TFT array substrate, and a liquid crystal layer disposed therebetween. As the TFT array substrate is provided with a plurality of conductive structures, the structure of the touch panel is usually arranged on the color filter substrate.

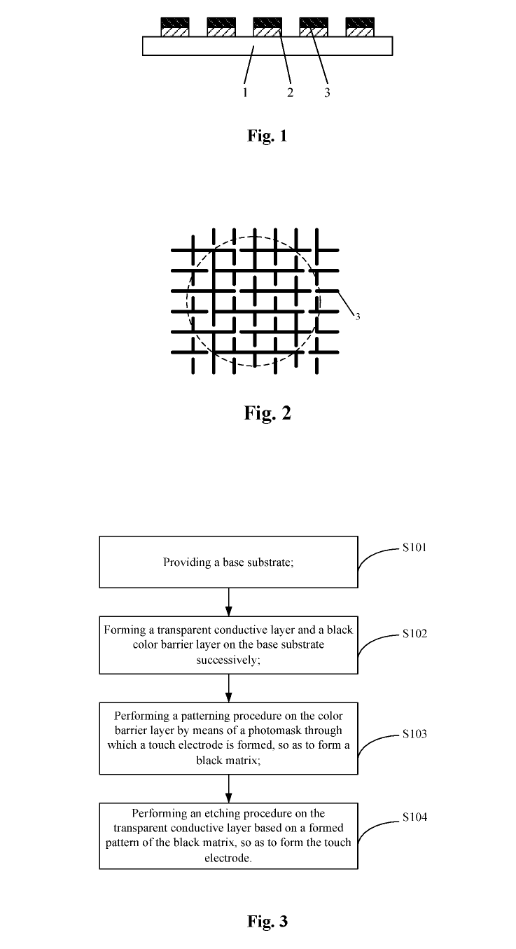

In view of the above, a touch panel arranged on a color filter substrate is provided in an embodiment of the present disclosure. The touch panel comprises a base substrate 1, a touch electrode 2, and a black matrix 3, wherein the touch electrode 2 is located on the base substrate 1, and the black matrix 3 is located on the touch electrode 2. Specifically, as shown in FIG. 1, the black matrix 3 and the touch electrode 2 have a same pattern, and completely coincide with each other.

In the embodiment of the present disclosure, the touch electrode 2 includes horizontal rows and longitudinal columns perpendicular to each other. Because the touch panel according to the embodiment of the present disclosure is self-capacitive, the touch electrode 2 is not continuous everywhere. Where the touch electrode 2 is discontinuous, two opposite fracture surfaces of the touch electrode 2 will form a capacitor. Electric charges in the capacitor will change upon a touch action exerted by a user, whereby the touch panel can detect the user's touch action.

Since the pattern of the black matrix 3 and that of the touch electrode 2 in the embodiment of the present disclosure are the same and completely coincide with each other, the black matrix 3 equally comprises horizontal rows and longitudinal columns perpendicular to each other. In the embodiment of the present disclosure, where the touch electrode 2 is continuously arranged, the black matrix 3 is continuously arranged also. Correspondingly, where the touch electrode 2 is discontinuously arranged, the black matrix 3 is discontinuously arranged also.

In the embodiment of the present disclosure, the touch electrode 2 is discontinuous at a connecting position between the horizontal row and the longitudinal column thereof. Therefore, as indicated within a dotted box in FIG. 2, the black matrix 3 is also discontinuous at a connecting position between the horizontal row and the longitudinal column thereof.

Obviously, in the embodiment of the present disclosure, due to location of the black matrix 3 on the touch electrode 2, the same and completely coinciding patterns between the black matrix 3 and the touch electrode 2, and different material of the black matrix 3 from that of the touch electrode 2, the black matrix 3 may not only shade light, but also function as a mask during formation of the touch electrode 2. This can both improve alignment accuracy between the black matrix 3 and the touch electrode 2, and save a photomask of the black matrix 3 or that of the touch electrode 2. Therefore, the technical solution provided in the embodiment of the present disclosure is beneficial in simplifying a manufacturing procedure, cutting down manufacturing costs, and improving manufacturing efficiency of the touch panel.

Specifically, in the embodiment of the present disclosure, a method of manufacturing the touch panel is further provided. As indicated in FIG. 3, the method comprises the following steps.

In step S101, a base substrate 1 is provided.

The base substrate 1, i.e., the base substrate 1 of the color filter substrate, can be made of a readily obtainable material which is of high transparency and low costs, such as tempered glass.

In step S102, a transparent conductive layer 4 and a black color barrier layer 5 are successively formed on the base substrate.

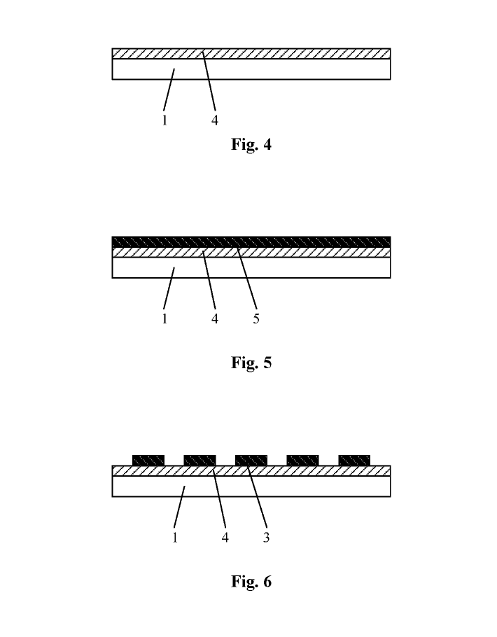

As shown in FIG. 4, the transparent conductive layer 4 is first formed on the base substrate 1, with a conductive material of high transparency such as Indium Tin Oxide (ITO for short) and Indium Zinc Oxide (IZO for short). The transparent conductive layer 4 can be formed through magnetron sputtering or chemical vapor deposition.

Subsequently, as illustrated in FIG. 5, the black color barrier layer 5 is formed on the transparent conductive layer 4. The black color barrier layer 5 can be formed through coating of black polymer resin.

In step S103, the photomask used for formation of the touch electrode is used to perform a patterning procedure on the black color barrier layer, to form a black matrix 3.

In the embodiment of the present disclosure, the black matrix 3 and the touch electrode 2 have a completely same pattern, and entirely coincide with each other. As the black color barrier layer 5 is located on the transparent conductive layer 4, the patterning procedure should be first performed on the black color barrier layer 5 to form the black matrix 3.

In the above embodiment of the present disclosure, the patterning procedure performed on the black color barrier layer 5 substantially comprises the following steps.

First, photoresist of certain thickness is coated on the black color barrier layer 5. The photoresist is a light-sensitive liquid mixture mainly composed of three components, i.e., photosensitive resin, sensitizer (see spectral sensitizing dyes), and a solution.

Since the photoresist is a liquid mixture, it is necessary to be prebaked at a certain temperature, so as to be cured, before being exposed through the photomask. Afterwards, the photoresist is exposed through the photomask used for formation of the touch electrode 2. Specifically, the photoresist is exposed to ultraviolet light having a wave length in the range from 200 to 450 nm. The duration of exposure, determined by thickness and type of the photoresist, can be controlled in the range from 20 to 180 s.

Subsequently, the exposed photoresist is developed. Due to the function of the photomask, the photoresist is only partially exposed. If the photoresist is positive photoresist, an exposed portion thereof would, because of variation in chemical components, be easily dissolved into a developing solution. As a result, after being developed, a non-exposed portion of the photoresist corresponding to a non-transparent area of the photomask would remain. That is, the photoresist is exposed and developed in order to transfer a pattern of the non-transparent area of the photomask onto the photoresist.

After the photoresist is developed, the black color barrier layer 5 will be only partially covered by the photoresist. At such a moment, the black color barrier layer 5 can be etched based on the pattern of the photoresist formed after development of the photoresist. Specifically, a portion of the black color barrier layer 5 covered by the photoresist is kept away from an etching solution and therefore completely remains; while a portion of the black color barrier layer 5 uncovered by the photoresist is etched by the etching solution and thereby completely removed. This is equivalent to transfer of the pattern on the photomask, by means of the photoresist, to the black color barrier layer 5. Thus, as FIG. 6 shows, the black matrix 3 required in the embodiment of the present disclosure is formed.

After the black matrix 3 is formed, a portion of the photoresist remains thereon. Hence, it is necessary to remove such remaining photoresist from the black matrix 3 through a stripping procedure.

In step S104, the transparent conductive layer is etched based on the pattern of the black matrix as formed, so as to form the touch electrode.

According to the embodiment of the present disclosure, the black matrix 3 may not only shade light, but also function as a mask of the transparent conductive layer 4 in subsequent steps. That is, engineers can etch the transparent conductive layer 4 directly based on the pattern of the black matrix 3 as formed. Because the transparent conductive layer 4 and the black matrix 3 are of different materials, the etching solution for the transparent conductive layer 4 cannot be used to etch the black matrix 3 so as to get in contact with a portion of the transparent conductive layer 4 covered by the black matrix 3, but instead, is only effective on a portion of the conductive layer 4 uncovered by the black matrix 3. Therefore, the transparent conductive layer 4 can be directly etched based on the formed pattern of the black matrix 3, so as to form the touch electrode 2, as shown in FIG. 1.

According to the manufacturing procedure of the touch panel provided in the embodiment of the present disclosure, a special photomask for the touch electrode 2 or the black matrix 3 can be saved on the one hand, thereby simplifying flow of the procedure, saving manufacturing time, improving manufacturing efficiency, and cutting down costs thereof. On the other hand, the black matrix 3 can be used as the mask for etching of the touch electrode 2, thereby achieving self alignment between the black matrix 3 and the touch electrode 2, improving alignment accuracy, and effectively preventing occurrence of the problem of Moiré.

The above embodiments are described only for better understanding, rather than restricting, the present disclosure. Any person skilled in the art can make amendments to the implementing forms or details without departing from the spirit and scope of the present disclosure. The scope of the present disclosure should still be subject to the scope defined in the claims.

1. A touch panel, comprising:
a based substrate;
a touch electrode arranged on the base substrate; and
a black matrix located on the touch electrode,
wherein the black matrix and the touch electrode have a same pattern, and completely coincide with each other.

2. The touch panel according to claim 1, wherein each of the black matrix and the touch electrode comprises horizontal rows and longitudinal columns perpendicular to each other.

3. The touch panel according to claim 2, wherein where the touch electrode is continuously arranged, the black matrix is continuously arranged also, and
wherein where the touch electrode is discontinuously arranged, the black matrix is discontinuously arranged also.

4. The touch panel according to claim 3, wherein the black matrix and/or the touch electrode are each discontinuous at a connecting position between corresponding horizontal row and longitudinal column.

5. A method of manufacturing a touch panel, comprising the steps of:
providing a base substrate;
forming a transparent conductive layer and a black color barrier layer on the base substrate successively;
performing a patterning procedure on the color barrier layer by means of a photomask with which a touch electrode is formed, so as to form a black matrix; and
performing an etching procedure on the transparent conductive layer based on a formed pattern of the black matrix, so as to form the touch electrode.

6. The method according to claim 5, wherein the step of performing a patterning procedure on the color barrier layer by means of a photomask with which a touch electrode is formed, so as to form a black matrix includes the sub-steps of:
forming photoresist on the black color barrier layer;
exposing the photoresist by means of the photomask with which the touch electrode is formed;
developing the photoresist that has been exposed; and
etching the black color barrier layer based on a formed pattern of the photoresist after being developed, so as to form the black matrix.

7. The method according to claim 6, wherein each of the black matrix and the touch electrode comprises horizontal rows and longitudinal columns perpendicular to each other.

8. The method according to claim 7, wherein where the touch electrode is continuously arranged, the black matrix is continuously arranged also, and
wherein where the touch electrode is discontinuously arranged, the black matrix is discontinuously arranged also.

9. The method according to claim 8, wherein the black matrix and/or the touch electrode are each discontinuous at a connecting position between corresponding horizontal row and longitudinal column.
